(19) United States
(12) Patent Application Publication
(10) Pub. No.: US 2011/0200314 A1
(43) Pub. Date: Aug. 18, 2011

(54) LIQUID LENS WITH TEMPERATURE COMPENSATED FOCUS TIME

(75) Inventor: Yasutake Kawashima, Saitama Pref. (JP)

(73) Assignee: Optoelectronics Co. Ltd., Saitama Pref. (JP)

(21) Appl. No.: 13/055,066

(22) PCT Filed: Aug. 12, 2008
(86) PCT No.: PCT/US08/72876

§ 371 Date: Mar. 24, 2011

(51) Int. Cl. G03B 13/18; G02B 1/06; G03B 13/00

(52) U.S. Cl. 396/106; 359/665; 396/89

(57) ABSTRACT

A temperature compensated liquid lens is disclosed in which wait times for the liquid lens to respond to an applied control voltage or calculated in advance and stored in a table. A temperature sensor is utilized with the liquid lens that provides temperature data to the controlled circuitry. The wait time for the liquid lens to respond is then minimized to be no more than the minimum required time for the liquid lens to respond to the controlled voltage enough to focus the image to a prescribed level of quality.

### BACKGROUND ART

The present convention relates generally to auto focus imaging systems, and more particularly, to imaging systems capable of reading effectively over a wide range distances from a near field to a far field. Such devices may also be used to capture images of symbols to be decoded, or as general imaging devices for capture of any type of image. When used to read and decode data symbols, these devices may be called code scanners, even though they are not “scanners” in the sense of more conventional laser scanners.

Imaging devices using liquid lenses have recently been introduced. Such liquid lens systems use a voltage that is applied to fluids, which voltage alters the shape of the surface of the fluids, creating lenses of varying properties. By varying the applied voltages correctly, the optical properties of the lens can be set as required in any particular application.

### DISCLOSURE OF INVENTION

In accordance with one aspect of the present invention, a code scanner, which illuminates a scanned code from a distance, includes a liquid lens that focuses the reflected image of the code on an image sensor. The scanner includes a range detector, preferably laser-based, which determines the distance to the scanned code, and the liquid lens is controlled to focus at the detected distance. The presence of a range detector is itself optional, and not critical to the present invention.

In accordance with an enhanced embodiment, the system includes a temperature sensor located proximate to the liquid lens. The temperature sensor is operable with a storage means that includes previously derived data indicating the length of time the lens will take to properly respond to—i.e; alter its properties in response to—an applied voltage. As these properties vary with temperature, the use of the previously derived data allows the system, after applying the proper voltage to the liquid lens, to wait the least amount of time possible before capturing the desired image.

### BRIEF DESCRIPTION OF DRAWINGS

The foregoing brief description, and other objects, features and advantages of the present invention will be understood more completely from the following detailed description of presently preferred, but nonetheless illustrative, embodiments in accordance with the present invention, with reference being had to the accompanying drawings, in which:

FIG. 1 is schematic diagram illustrating a code scanner embodying the present invention;

FIG. 2 is block diagram of an imaging device including a temperature sensor located proximate to the liquid lens;

FIG. 3 depicts a graph comparing the response times of liquid lenses to an applied voltage at different temperatures; and

FIG. 4 is a graph showing how response time of a liquid lens varies as a function of temperature

### BEST MODE OF CARRYING OUT THE INVENTION

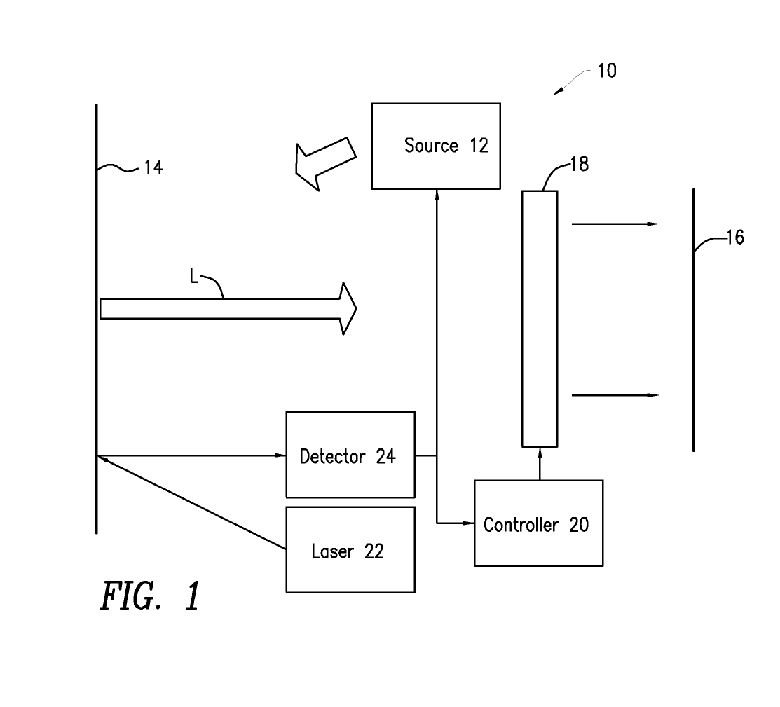

Turning now to the details of the drawings, FIG. 1 is schematic diagram illustrating a code scanner 10 embodying the present invention. The scanner 10 has a light source 12, which illuminates an optical code 14, such as a barcode, at a distance. The light L reflected from barcode 14 forms an image on image sensor 16, which is processed to decode the bar code 14.

A liquid lens 18 is interposed in the light path L between bar code 14 and image sensor 16. Those skilled in the art will understand that this is an electro optical type of device which has a optical interface between two transparent layers. Through the adjustment of an applied voltage, the shape of that interface maybe changed, changing the focal length of the lens. The distance between the lens 18 and image sensor 16 remains fixed, however, the distance to the left of lens 18 of the plain on which the lens will focus will vary with the applied voltage. It is therefore possible to focus barcodes 14 at a range of distances from image sensors 16 by simply varying a voltage that controller 20 applies to lens 18. Mechanical movement of the lens is not necessary. However, it will be appreciated that the control voltage applied to lens 18 must be correlated to the actual distance of barcode 14 from lens 18 and, therefore, from image sensor 16.

In order to ensure appropriate control of lens 18, a ranging apparatus is provided which preferably comprises a laser device and a laser detector 24. Two types of laser ranging technology are well known in the art. Pulsing technology measures the delay time between the initiation of a laser pulse and the return of its reflection. Parallax technology projects a light beam to form a spot on a target and then measures the position of the detected spot on the target. The distance of the target can be determined from the position of the detected spot. Preferably, laser device 22 and detector 24 define a parallax ranging subsystem. Laser 22 projects a light beam onto bar code 14 and detector 24 senses the position of the resulting dot and determines the distances of bar code 14. It then produces a signal representative of that distance, which is applied to controller 20. In response, controller 20 is then able to apply a voltage to lens 18 to focus it appropriately.

The output signal of detector 24 is also applied to light source 12, the intensity of which is controlled accordingly. In its simplest form, source 12 could be a ray of light emitting diodes, and the intensity could be controlled by the numbers of diodes on the array that are turned on (more simply by changing optical output power). The intensity of light source 12 could also be controlled by varying the dispersion angle of the light at the midst. Those skilled in the art will appreciate that that could be achieved mechanically by controlling the angle of vain-like devices or the like, or it can be achieved optically with a condensing lens. It would be possible to provide a plurality of condensing lens and select among them or to provide a zooming lens, possibly even a liquid lens.

In any event, through the controller focus distance and light source illumination in relationship to the distance of the bar code, it becomes possible to achieve DOF performance which approaches the ideal.

Preferably, liquid lens 18 is ARCTIC-414 or ARCTIC-416 produced by Varioptic. However, other liquid lenses may be utilized as well.

In a preferred arrangement, the laser is mounted atop of the camera module, instead of at the sides or on the bottom. Additionally, the laser should be offset from the optical axis by an amount equal to 6-15 mm. Moreover, if a LEDs are used for illumination, they should be mounted on the opposite of the module from the laser, in order to minimize the effects of reflection.

As indicated previously the present invention exhibits advantages over the prior art in that it is capable of focusing a code image more quickly, in that it avoids the use of moving parts, eliminating the associated reliability issues; in that it has a substantially greater focus range; and in that it is easily retrofitted into existing scanning systems

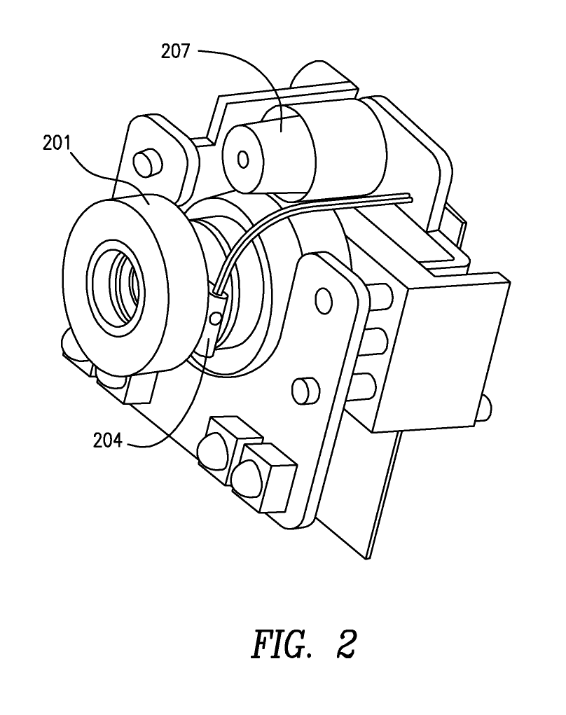

FIG. 2 depicts an exemplary 2D imaging device including a liquid lens 201 and a temperature sensor 204 placed proximate to the liquid lens as shown. A laser ranging device 207 is installed just above the liquid lens as shown. The temperature sensor 204 is connected with the control circuitry (not shown) to cause the temperature to be accounted for in determining how long after application of the proper voltage to the liquid lens the system should wait before capturing the image.

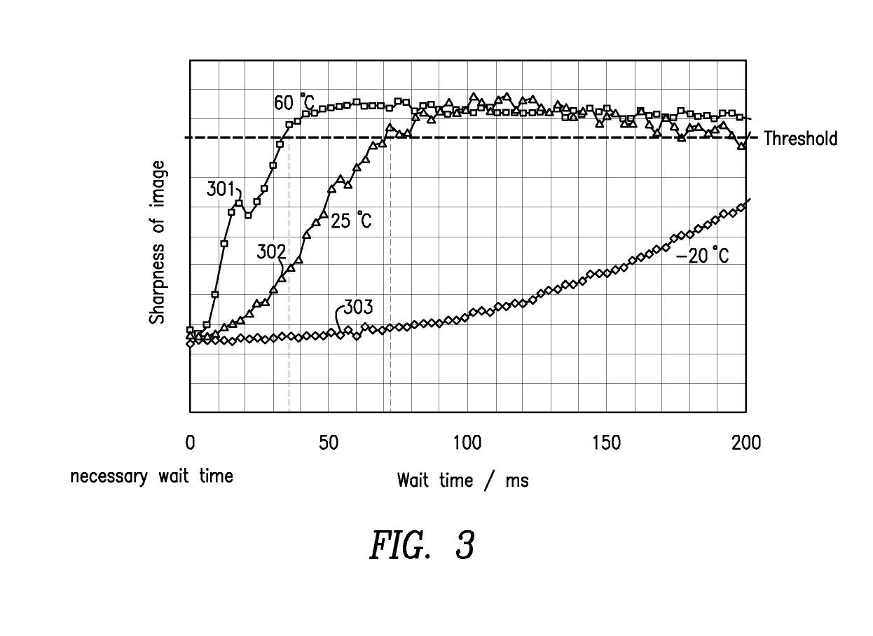

FIG. 3 shows a set of graphs 301-303 representing the response time of an exemplary liquid lens at three different temperatures as shown. Specifically, for a liquid lens to focus to a prescribed level of image sharpness, the weight time at 60° C., for example, would be significantly less than the wait time at 25° C. as shown. While various liquid lenses may react differently, for any given liquid lens or type of liquid lens, empirical data can be used to generate the appropriate values of wait time. The lens's response time can simply be tested to generate the table of relevant wait times.

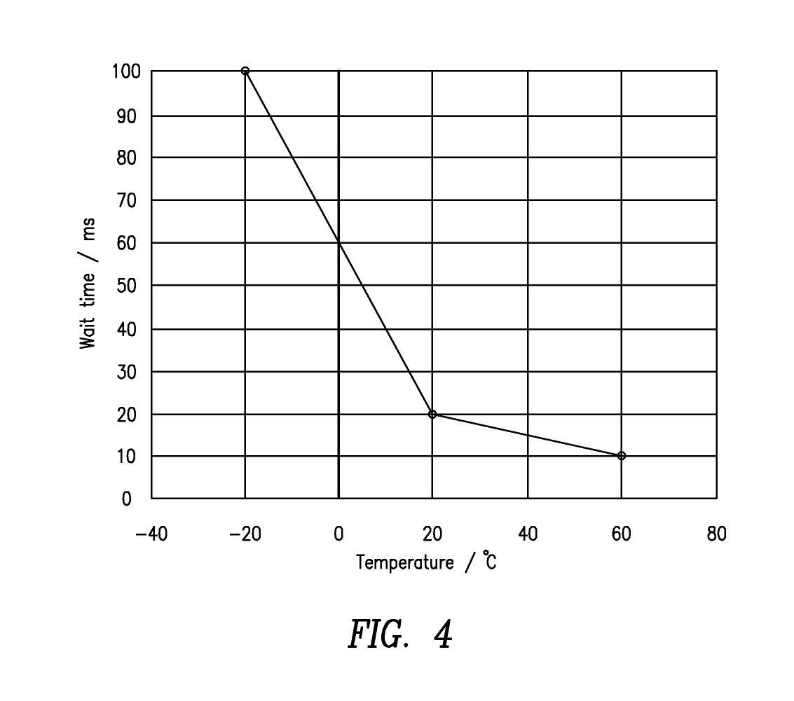

FIG. 4 depicts a single graph of the appropriate wait time as a function of the temperature measured by the temperature sensor 204. By programming the control circuitry of the image capture device such that the image is captured after the minimum wait time, the system waits enough time to provide an image at least as sharp as a threshold prescribed for proper decoding, but the system does not wait too long resulting in lower speed and lower capacity.

Since differing temperatures mandate differing wait times, the temperature value may be updated as the device operates. In a preferred embodiment, the controller is programmed to required a temperature update periodically. Alternatively the update can be provided whenever the temperature sensor detects a change in temperature my more than a prescribed amount.

While the foregoing describes the preferred embodiment of the invention, various other modifications and additions will be apparent to those of skill in the art. Such modifications and additions are intended to be covered by the claims appended hereto.

1. An imaging device comprising a lens and a control system for providing a focusing signal and causing said device to capture an image after a specified response time, said response time being dependent upon a temperature measured.

2. An imaging device of claim 1 further comprising a laser ranging device and a temperature sensor placed proximate to said liquid lens, and wherein said temperature sensor data is read periodically by said control system, and wherein said control system updates wait times based upon said temperature sensor data.

3. A method of capturing an image comprising applying a voltage to a liquid lens, waiting a predetermined time for said liquid lens to respond to said voltage, and capturing said image, wherein said predetermined time is so predetermined based at least in part upon information from a temperature sensor mounted to an image capture device capturing said image.

4. The method of claim 3 wherein said predetermined time varies as a function of temperature in a substantially linear manner.

5. The method of claim 4 wherein said predetermined time varies as a function of temperature in a linear manner having a first slope for all temperatures above a predetermined temperature, and having a second slope for all temperatures below said predetermined temperature.

6. An imaging device having a lens, a temperature sensor, and storage, said storage including a set of values, said values being indicative of an amount of time that said device should allow from application of a control signal to focus said lens until image capture, said amount of time being at least partially dependent upon a measured temperature.

7. The device of claim 6 wherein temperature sensor information is periodically sent to a controller.

8. A method comprising applying a voltage to a liquid lens, waiting a predetermined time for said lens to respond to said voltage by changing its optical properties, and changing said wait time automatically in response to a sensor sensing an environmental change.

9. The method of claim 8 wherein said sensor is a temperature sensor.

10. The method of claim 9 wherein said sensor is periodically monitored to provide updated temperature information.
